(19) United States
(12) Patent Application Publication
(10) Pub. No.: US 2008/0126936 A1
(43) Pub. Date: May 29, 2008

(54) Electronic/software multimedia library control system and methods of use thereof

(76) Inventor: Gary Williams, Costa Mesa, CA (US)

Correspondence Address: BUCHALTER NEMER, 18400 VON KARMAN AVE., SUITE 800, IRVINE, CA, 92612, US

(21) Appl. No.: 10/921,199

(22) Filed: Aug. 17, 2004

Related U.S. Application Data
(60) Provisional application No. 60/497,398, filed on Aug. 21, 2003.

(51) Int. Cl. G06F 3/048; G06F 17/00

(52) U.S. Cl. 715/717; 707/104.1; 707/E17.101; 707/E17.028

(57) ABSTRACT

A media management system is described herein that includes: a) a computer, b) a media library comprising information related to a plurality of media, c) at least one device that can utilize and/or access at least part of the media library, d) a software code that executes a media library management system on the computer, wherein the media library management system accesses or manipulates the information related to at least part of the plurality of media in the media library or the at least one device, and e) a graphical user interface that is coupled to the computer. Methods of controlling a media library are also described that include: a) providing a media library comprising information related to a plurality of media, b) providing at least one device that can utilize and/or access at least part of the information related to the plurality of media in the media library, c) providing an executable media library management system; and d) utilizing the management system to manage at least part of the information related to the plurality of media in the media library, to operate the at least one device or a combination thereof. A graphical user interface is also disclosed herein that includes: a display device; and a projected image that graphically displays a set of media information collected by a multimedia library control system software.

This application claims priority to U.S. Provisional Patent Application Ser. No. 60/497,398 filed on Aug. 21, 2003, which is incorporated herein in its entirety by reference, including the Compact Disc-Read Only Memory that was submitted in duplicate with the US Provisional Patent Application and has the Registration Number 030820_{—}1322.

### FIELD OF THE SUBJECT MATTER

The field of the subject matter is a multimedia library control system and the related software and hardware for the system.

### BACKGROUND OF THE SUBJECT MATTER

The home theater market has been growing at a fast pace during the last several years, and along with this growth has been an increase in the complexity of the home theater devices. Today, the market contains DVD jukeboxes that can hold hundreds of CDs and DVDs or even more when connected together. The same market contains satellite receivers that can receive hundred of channels, personal video recorders that can record television shows for the users and store those shows on a hard disc, tape or Readable-Writable CDRom, and personal computer files that can be copied from a CD or downloaded from the Internet.

The complexity of these devices is compounded by different modes in which each of these devices may operate. A DVD audio disc usually requires a different sound mode in the receiver than a CD. DVD video discs may contain the soundtrack in several different formats (Dolby Surround, DTS), and in different aspects (widescreen, or 2.35:1, full frame/pan and scan, or 4:3). Television sets contain multiple inputs to connect to the user's equipment.

Along with the complexities previously described, each component also typically ships to the consumer with its own remote controls. There are a number of universal remote controls, where the remote control is programmed to understand the infrared codes of other remote controls.

The result of combining these complexities and controls is that the typical consumer of these products cannot manage and control the entire home theater. The universal remote controls can be difficult to program, and many consumers do not take the time to understand the different modes available in a home theater systems.

U.S. Pat. No. 6,097,380 strictly defines a set of device control interfaces, intended to control devices contained within a computer case; however, the '380 patent does not claim any mechanism or method for a device to report a change in status back to the host application. U.S. Pat. No. 5,864,868 discloses controls for the movement of media only—such as play, pause and stop. In addition, the '868 patent does not describe how multiple devices could be manipulated or controlled. U.S. Pat. No. 6,118,450 specifically relates to a graphical user interface to a multidisc CD player. While the '450 patent relates to controlling a multidisc CD player, no other devices are described or contemplated.

Accordingly, it would be beneficial to develop a software/electronic multimedia library control system that allows users to manage home theater devices and the accompanying media contained in or on those devices or available to those devices. Furthermore, the software system should control those home theater systems and devices using the methods most appropriate for the system and/or the device. The home theater system should include devices, such as but not limited to, a CD or DVD jukebox, a satellite receiver, a personal video recorder such as a TiVo™, personal computer media, music or movie files, or even the FM radio stations. The devices should contain media, as in the case of a CD or DVD jukebox, the devices should require media to be inserted, such as a single disc DVD player, the devices should be able to access media via a signal, such as a digital signal, an analog signal, a satellite signal, etc, or the devices should be able to contain/access media by a combination thereof. The executable software system should allow the user to access a library containing a plurality of media and store information related to at least part of the plurality of media in a computer database, where the information can be used later by the user to search for media matching the user's requirements. The software system should be further enhanced by the use of LCD touch panels, such as a Smart Display, which can operate in a wireless mode and is an LCD monitor with an 802.11b adapter built in to the monitor.

### SUMMARY OF THE SUBJECT MATTER

A media management system is described herein that includes: a) a computer, b) a media library comprising information related to a plurality of media, c) at least one device that can utilize and/or access at least part of the media library, d) a software code that executes a media library management system on the computer, wherein the media library management system accesses or manipulates the information related to at least part of the plurality of media in the media library or the at least one device, and e) a graphical user interface that is coupled to the computer.

Methods of controlling a media library are also described that include: a) providing a media library comprising information related to a plurality of media, b) providing at least one device that can utilize and/or access at least part of the information related to the plurality of media in the media library, c) providing an executable media library management system; and d) utilizing the management system to manage at least part of the information related to the plurality of media in the media library, to operate the at least one device or a combination thereof.

A graphical user interface is also disclosed herein that includes: a display device; and a projected image that graphically displays a set of media information collected by a multimedia library control system software.

### BRIEF DESCRIPTION OF THE DRAWINGS

FIG. 1 shows a contemplated media library management graphical user interface (“GUI”).

FIG. 2 shows a contemplated media details GUI.

FIG. 3 shows contemplated media details for the Credits tab.

FIG. 4 shows contemplated media details for the Contents tab.

FIG. 5 shows contemplated media details for the Attributes tab.

FIG. 6 shows the contemplated media details for the Record Options tab

FIG. 7 shows the contemplated media control form

FIG. 8 shows a contemplated sample search GUI.

FIG. 9 shows a contemplated sample search results GUI.

FIG. 10 shows a contemplated device selection process.

FIG. 11 shows a contemplated device command loading process.

FIG. 12 shows a contemplated database schema related to device control.

FIG. 13 shows a contemplated database schema related to the media library.

FIG. 14 shows a contemplated hardware arrangement.

FIG. 15 shows a contemplated hardware arrangement.

FIG. 16 shows a contemplated device description file.

FIG. 17 shows a contemplated device definition GUI.

FIG. 18 shows a contemplated device configuration.

FIG. 19 shows a contemplated device configuration.

FIG. 20 shows a contemplated device configuration.

FIG. 21 shows a contemplated device configuration.

FIG. 22 shows a contemplated device configuration.

FIG. 23 shows a contemplated device configuration.

FIG. 24 shows a contemplated device configuration.

Table 1: A catalog of the files contained on the “Electronic Multimedia Library Patent” CD Rom, along with the size of each file and the date created on the “Electronic Multimedia Library Patent” CD Rom.

Appendix A: A catalog of the files contained on the “Electronic Multimedia Library Patent” CD Rom, file folder “PDFs-2 Page” and Source Code for A Contemplated Embodiment of the Multimedia Library Control System Software.

### DETAILED DESCRIPTION

As mentioned, it would be beneficial to develop a software/electronic multimedia library control system that meet the following goals: a) allows users to manage home theater devices and the accompanying media contained in or on those devices or available to those devices; b) controls those home theater systems and devices using the methods most appropriate for the system and/or the device; and c) includes devices, such as but not limited to, a CD or DVD jukebox, a satellite receiver, a personal video recorder such as a TiVo™, personal computer media, music or movie files, or even the FM radio stations. The devices should contain media, as in the case of a CD or DVD jukebox, or the devices should require media to be inserted, such as a single disc DVD player. Additional goals are that the software system allows the user to store information in a computer database, where the information can be used later by the user to search for media matching the user's requirements and the system is further enhanced by the use of LCD touch panels, such as a Smart Display, which can operate in a wireless mode and is an LCD monitor with an 802.11b adapter built in to the monitor.

In order to address the goals previously mentioned, a software/electronic multimedia library control system has been developed that allows users to manage home theater devices and the media these users have contained in or on those devices or available to those devices. Furthermore, the software system described herein controls those home theater systems and devices using the methods, modes and controls most appropriate for the system and/or the device. The home theater system contemplated includes devices, such as but not limited to, a CD or DVD jukebox, a satellite receiver, a personal video recorder such as a TiVo™, personal computer media, music or movie files, or even the FM radio stations. The devices contain media, as in the case of a CD or DVD jukebox, or the devices require media to be inserted, such as a single disc DVD player. Contemplated software and related systems allow the user to store information in a computer database, where the information can be used later by the user to search for media matching the user's requirements. The software system is also further enhanced by the use of LCD touch panels, such as a Smart Display. Also, as contemplated herein, consumer electronics devices are controlled by the software and systems described in a uniform manner. The electronic/software library system disclosed herein teaches methods for reporting status change and methods for the device to return media library information to the host application. In the case of a DVD jukebox, the electronic/software library system can report which slots in the jukebox contain discs, the type of disc, even the table of contents for the disc.

A media management system is described herein that includes: a) a computer, b) a media library comprising information related to a plurality of media, c) at least one device that can utilize and/or access at least part of the media library, d) a software code that executes a media library management system on the computer, wherein the media library management system accesses or manipulates the information related to at least part of the plurality of media in the media library or the at least one device, and e) a graphical user interface that is coupled to the computer. Methods of controlling a media library are also described that include: a) providing a media library comprising information related to a plurality of media, b) providing at least one device that can utilize and/or access at least part of the information related to the plurality of media in the media library, c) providing an executable media library management system; and d) utilizing the management system to manage at least part of the information related to the plurality of media in the media library, to operate the at least one device or a combination thereof.

As opposed to previously-described art, contemplated embodiments described herein not only can control the movement of media (such as play, pause, stop), but can control multiple devices. When a media is selected, the system described herein can control multiple consumer electronics devices, including but not limited to the receiver, the player, and the television. In addition, a contemplated system “understands” (can differentiate and process) different modes of operation in each of these devices, such as the difference between the widescreen aspect ratio of a television (sometimes called 16:9 aspect ratio) and the normal television aspect ratio (sometimes called 4:3 aspect ratio), or different audio modes in the receiver, such as DVD Audio, DTS, THX, or Dolby Surround. Several contemplated systems also comprise security mechanisms to prevent children from viewing or listening to content that a parent deems inappropriate for the children, based on criteria such as genre or movie rating. Electronic program guides are also contemplated herein to assist the user with selecting a show to watch or record.

The electronic/software system uses the computer format and the related software to integrate described devices and media into a single point in order to organize the media and control the devices. The computer allows the users of the software to search the database by many views, including by media type (music or movie), by title, by rating, genre, or even by artist.

Each consumer has their own set of CDs, DVDs, PC music or movie files, FM radio stations or TV channels that they watch or listen to for enjoyment. For each consumer, this library is dynamic, whose contents may change over a period, particularly with devices such as a personal video recorder. Contemplated embodiments provide methods and systems for managing the set or plurality of media and the information related to the plurality of media owned by a consumer, collectively known as the “media library”. Disclosed embodiments also provide methods and systems for controlling home theater devices using information from the media library. A typical home theater at a minimum contains a receiver, a DVD player, television or a combination thereof. Most also include a cable box or satellite receiver, a VCR and some contain additional devices. A majority of homes also have one or more PCs, with music or videos contained on one or more of those PCs. Most homes also have at least a small collection of movies, either in DVD or videotape, and most also have several CDs. Each source of music, movie, television or radio station or recorded show that is part of the media library is herein referred to as “media”. A plurality of media and the information related to that media make up the media library.

In one contemplated embodiment, the media library management system or media management system (the phrases “media library management system” and “media management system” mean the same system and may be used interchangeably) collects the computer-readable information about these media (but not the contents, so as not to violate any applicable copyright laws) and stores it in a computer database. The actual media continue to reside on the devices that contain the media, and it should be understood that the electronic/software library system disclosed herein is not actually storing the media contents in the database, so as not to violate any applicable copyright laws. The computer-readable information about each media may be supplied by the electronic/software system itself, by searching the Internet and downloading the information, or manually entered by the consumer.

The computer-readable information about each media at a minimum should include the media type, title and device to play the media. The media type may be CD, DVD, DVD audio, AM radio, FM radio, TV channel, a TV series, a single recorded episode of a TV show, an individual music track, generic music, generic video, a playlist or a combination thereof. Optional information for the media includes a description, the location, length of the media (in minutes), rating, genre, credits, a unique identifying string, bitmapped images for the media, and the collection of media items contained by this media. Each item in the collection is also a media, thus allowing a virtually unlimited nesting of media. An example of the collection of contained media items for a CD would include the individual tracks of the CD. A playlist comprises a user defined collection of media, which may be on different devices. For example, a playlist may contain a track from a CD, a television station on the satellite and a PC music file.

### Media Library

A contemplated media library comprises a plurality of media and information, such as computer-readable information, about the plurality of media, which comprises music, movies, television stations, radio stations, PC music and video files, and shows recorded on a personal video recorder. Some of the relevant information in the media library includes the media type, title, descriptive text field, location, credits for performers on the media, length, computer readable bitmapped images for the artwork, and table of contents. It should be understood that not all fields are present for all media.

A contemplated media library is created using information gathered from multiple sources. Devices capable of two-way communications via some sort of computer interface such as RS-232 or Ethernet may be able to provide some of the information, with the rest or the information provided by the user or from the Internet. For example, a TiVo™ can provide all of the necessary information for the media library, including the names of recorded shows, ratings, genre and credits. A CD changer can provide a list of slots that contain discs, and can provide the table of contents for a given disc, but the remaining information about the disc such as the title, the tracks, artists, rating and genre the user must download from the Internet or enter it manually. A DVD recorded with a writable DVD device usually does not contain any information other than a unique disc ID, and the user must enter in all remaining information. A CD changer without a computer interface and operated only using infrared would require the user to enter the location and title of each disc, with the rest downloaded from the Internet.

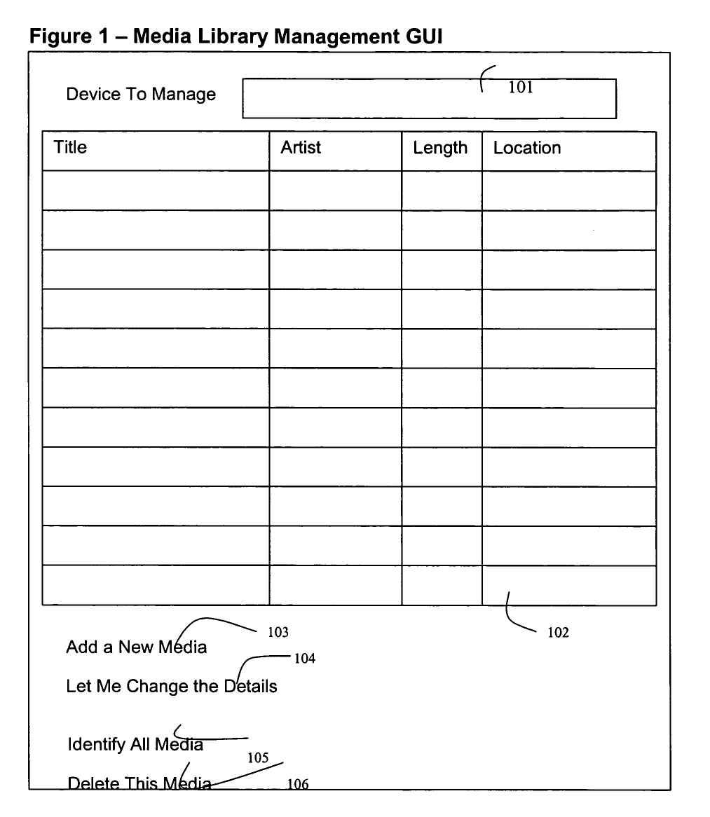

FIG. 1 shows a contemplated graphical user interface (otherwise referred to herein as “GUI”) 100 for managing the library. The graphical user interface may comprise a display device, such as a computer screen, a monitor, a handheld device, an LCD screen or display, a TV screen, a laptop computer screen or a combination thereof, along with a projected image that graphically displays the media details and information collected by the multimedia library control system software in a user-friendly format, as is shown in additional figures. The graphical user interface may be manipulated by a connected keyboard, may be voice activated, may be manipulated by a pointer or other selection device or may be manipulated by touch.

The set of media for any given device will change, and this sample GUI shows that. The user may select from the list of devices 101 configured by the user. The resulting list of media 102 for that device is displayed. In this Figure, the device to manage is a CD player 108 and the list of media comprises a list of CDs 110 in the CD player 108. In this embodiment, the list of CDs 110 is arranged by Title 112, Artist 114, Length 116 and Location 118. A user can click on the Title 112 and see a list of the songs included. A user can click on the Artist 114 and see all of the media in the library by that artist. As mentioned, any device being managed may be shown at the GUI.

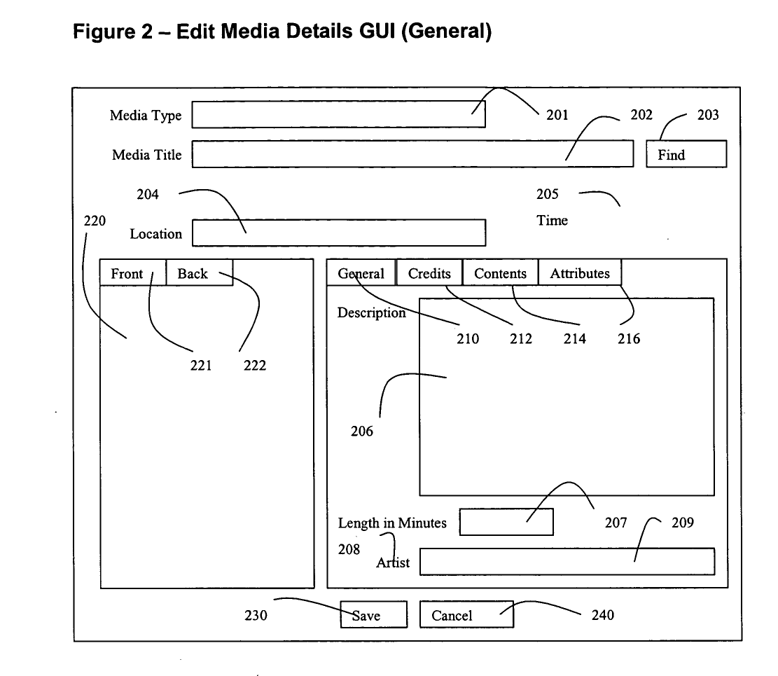

If the user wishes to add a media not in the list they may click “Add a New Media” 103, and they will then see FIG. 2. The user may click on an item in the list 102, then click “Let Me Change the Details” 104 to edit the media details, and they will then see FIG. 2. For those devices that can provide the media library information to the application, the user can click “Identify All Media” 105 to begin the process of sending media library information to the application. Sending the media library information is typically an asynchronous operation, because it can be lengthy, and because in the case of a CD or DVD jukebox, the device must select discs and read them one at a time. Finally, after the user has selected an item in the list 102, they may click “Delete This Media” 106 to delete the media from the library.

FIG. 2 shows a contemplated GUI 200 to allow a user to enter or change media details. When adding a new media, the media type combo box 201 is enabled and filled in with list of media types supported by the device. When editing an existing media, the media type combo box 201 is not enabled. The media title box 202 allows the user to enter the full or partial media title. If only a partial title is entered, the user may press the “Find” button 203 to initiate a search of the title from the Internet. The “Location” box 204 is the location of the media, which could be the slot number for a jukebox, the channel number for a satellite receiver, the FM frequency (i.e. 95.5) for an FM station, and the name of a file for a PC file. The time the media was released or recorded is shown in the time field 205. If the user searched the Internet for the media and found it, the artwork is displayed in box 220, and the remaining fields are filled in with the information found including the description 206, the length of the media 207. For the Artwork box 220, the user can click on the Front 221 tab to see the front of the artwork or the Back 222 tab to see the back of the artwork. For the box that includes the description 206 and the length of the media 207, the user can click on other tabs that give General information 210, Credits 212, Contents 214 and Attributes 216. For music-based media, the label 208 says “Artist” and the artist name is entered in the text box 209. For video-based media, the label 208 says “Rating” and the rating is entered in the text box 209. In addition, the user can choose to “Save” 230 or “Cancel” 240 the action.

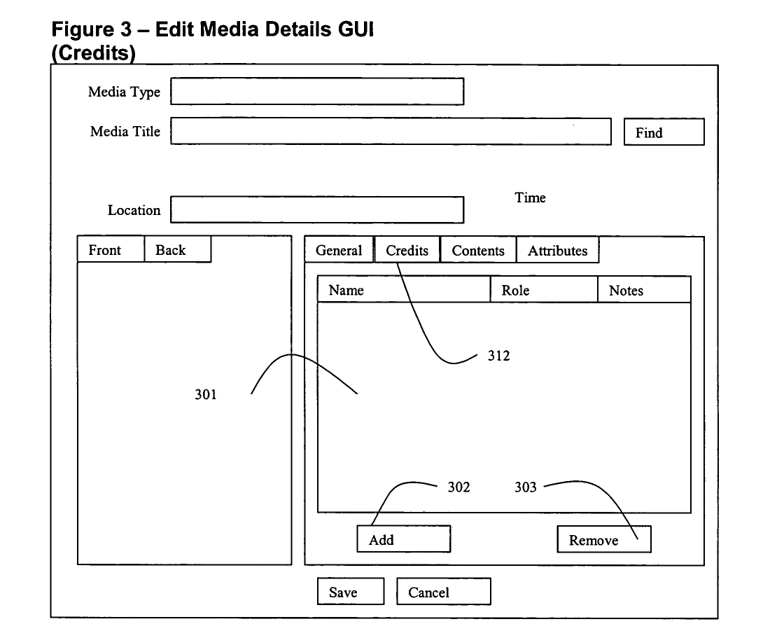

FIG. 3 shows the same GUI 300 with the same contemplated media edit form as in FIG. 2, but with the Credits tab 312 selected. In this view, the list of the artists 301 and their roles on the media are listed. For a music CD, this lists the performers and the instruments they played. For a movie, this lists the actors, directors, and producers from the movie. The information listed on this tab is dependent on the information downloaded from the Internet. Since the credits may not always be available for information downloaded from the Internet, there is also an Add button 302 and a remove button 303 to allow a user to manually add or remove credits.

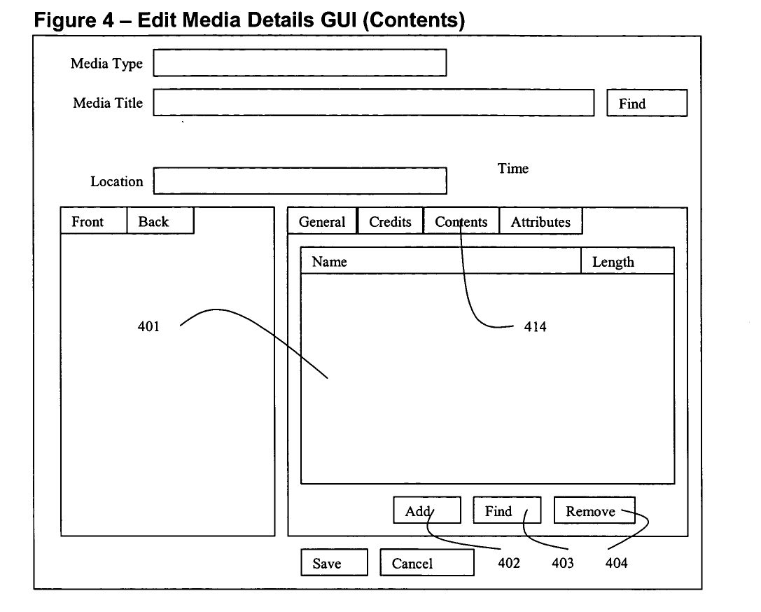

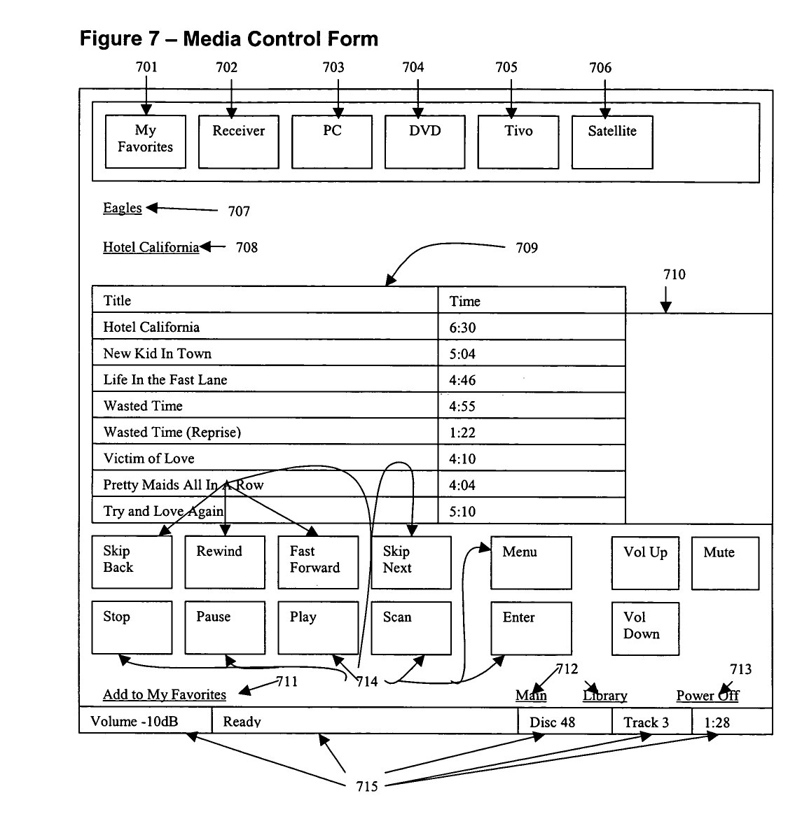

FIG. 4 shows the same GUI 400 with the same contemplated media edit form as in FIG. 2, but with the Contents tab 414 selected. In this view, the list of titles 401 on the media is shown along with their length. The user can press the Add button 402 to add a title to the list, the Find button 403 to find items to add or the Remove button 404 to remove a title from the list. The primary purpose is to show the contents of a media if available. The user can add contents items, such as DVD titles or chapters, since this information is not commonly available. The contents tab is also used when creating playlists. The Find button 403 takes the user to a contemplated Search form in FIG. 7.

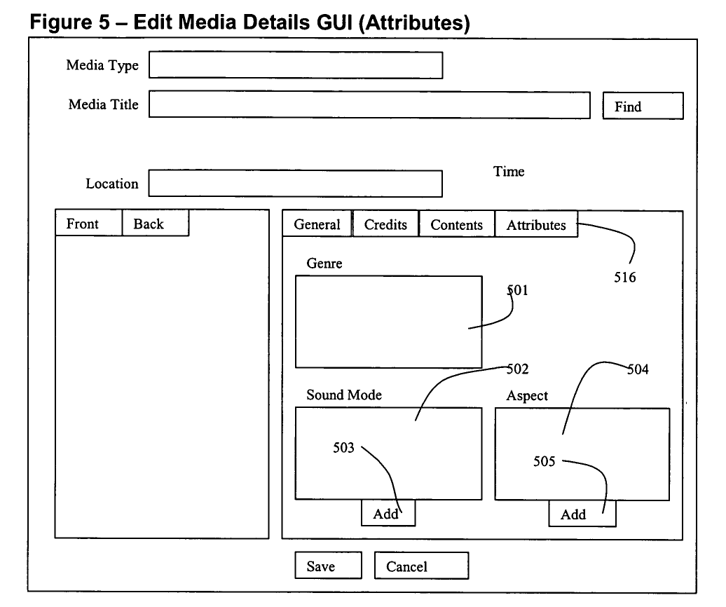

FIG. 5 shows the same GUI 500 with the same media edit form as in FIG. 2, but with the Attributes tab 516 selected. In this view, the list shows the set of attributes that apply. This view contains the genre for the media 501, the sound modes for the media 502 and the aspect for the media 504. If the media contains a sound mode not listed in 502, the user may press the Add button 503 to add a sound mode. If the media contains an aspect not listed in 504, the user may press the Add button 505 to add an aspect mode. It may be necessary to add the aspect ratio or sound mode if this was not available for the media, such as a DVD-R disc.

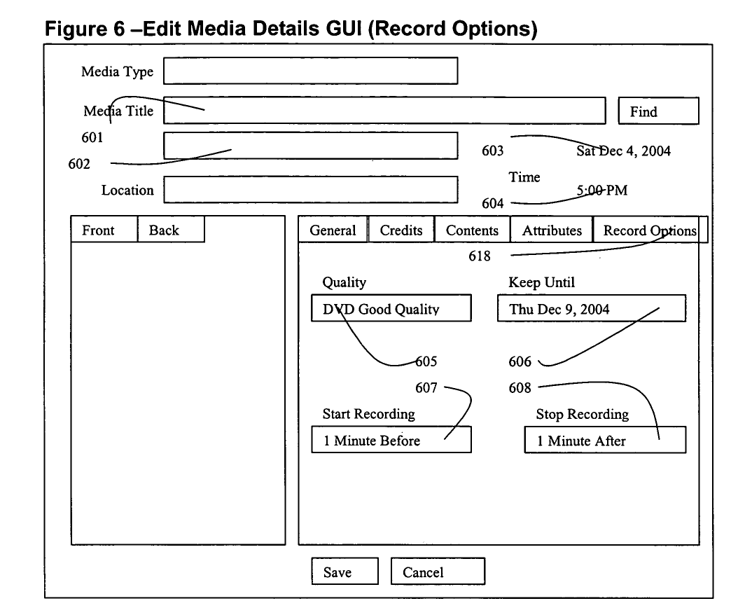

FIG. 6 shows the same GUI 600 with the same media edit form as in FIG. 2, but with the Record Options tab 618 selected. This view is seen when recording television shows. In this view, the name of the show is in the Media Title box 601, and the episode name is in the second media title box 602. The date of the show is in the date box 603 and the time of the show is in the time box 604. The user may choose the defaults for the recording including the quality of the recording 605, the minimum length of time to keep the recording 606, the time to pad the start of the recording 607, and the time to pad the end of the recording 608.

### Device Control

One contemplated embodiment uses the media library to select devices. There are three different categories for device control: those that apply to any media within the device, those that apply to particular media type in the device (such as DVD or CD), and those that apply to a specific media. This embodiment uses computer-readable information from the media library to control the devices, such as turning the devices on or off, changing the volume, selecting correct inputs and setting modes appropriate for an individual media selected by the user. The three categories of device control are combined during the media selection process to produce optimal results for a given media.

Each device managed by the electronic/software system described herein may have different communications protocols. Some devices only have infrared signals for control; some devices have a computer interfaces. However, the device interface embodied within the software provides a uniform interface to access these disparate devices. This uniform device interface defines both device control methods (stop playing, pause or fast forward) as well as media control methods (select a specific media). Each device driver must implement these interface methods. The uniform device interface also defines media library methods, such as enumerate all media on the device, and add a media. Not all devices can implement the enumerate method, in which case the method does nothing. An infrared controlled device is an instance of a device that cannot implement the enumerate method.

The device interface also defines a status event, which allows the device to send asynchronous status information to the host application. As long as the host application remains subscribed to the status event, it can receive notification from the device at any time. Status information sent can include the current media, the playback state (paused, stopped, playing, fast forward), the position within the media, the playback speed, the current volume, and an array of status strings that may be displayed at the bottom of the screen.

### Media Attributes Collection

The “media attributes collection” is the set of attributes that apply to a given media. These attributes may include the genre, the rating, audio modes, or aspect ratio for the media. The media attributes collection is stored in a computer readable database. The media attributes collection is one aspect of the disclosed subject matter that makes the embodiments unique, because the media attributes are used to set audio or video modes, to find media items to play, and to filter content inappropriate for children. Media attributes and the device control are used to set modes in the devices controlled by this system. The modes set by this system include the correct sound mode in the receiver or the correct aspect ratio on the television.

### Playing a Media

Searching for media and managing the library is not enough. To be useful for controlling a home theater, there also must be a way to see the current contents of the media and to control the playback of the media. FIG. 7 shows a contemplated GUI 700 for playing media. Along the top is a series of buttons for selecting the device to display in the title list 709. There is a button for My Favorites 701, a button for the receiver 702, a button for the PC 703, a button for the DVD player 704, a button for a TiVo 705, and a button for a satellite receiver 706. Under that row of buttons is the artist name 707, if available, for the current media, the title of the current media 708, and the contained items on the media 709, along with the times for each contained item. The description can be displayed for the selected item in text box 710. There are some links along the bottom to provide a minimal menu, including a button 711 to add the current media to the user's favorites, links 712 to go to other forms, and a link 713 to turn the power off for the system. There is a set of buttons 714 to control playback and the volume of the receiver. There is a status bar 715 to show text status strings.

### Searching for Media

One of the benefits of the systems described herein is to make it easy to select media. Users are generally name and attribute-oriented (such as the channel “ESPN”™), not number oriented (such as channel 206). In order to address this characteristic of most users, methods are described for searching the media library in a number of different ways: by media type (movie, music, channels), by rating, by genre, searching for an artist name, or searching by title. When searching the media library by title, the user may enter a partial title, with the result that searching for “Cal” for example may yield “Hotel California”, “Calcutta Nights” and “Call of the Wild”. When searching the media library by artist, the user may enter a partial name, with the result that searching for “Ford” for example may yield “Harrison Ford” or “Robert Redford”.

Further, the search can be performed across multiple libraries at the same time. One such library is the content of the media the user owns, such as their DVDs, CDs, radio and television stations. Another such library is the electronic program guide. Thus, when searching for the name “Ford” as in the previous example, the search can be performed against both the media the user own as well as broadcast shows in the present and future.

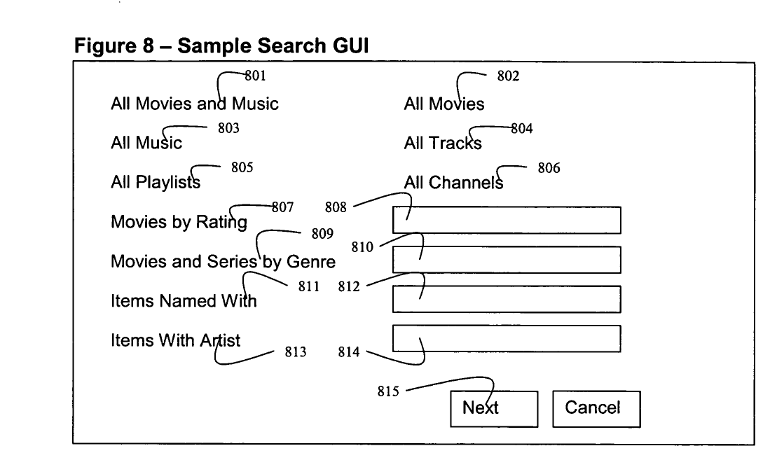

FIG. 8 shows a contemplated GUI 800 for searching the media library. The user may click on “All Movies and Music” 801 to return the set of all movies and music in the library. The user may click on “All Movies” 802 to return the set of all movies (DVDs and videos) in the library. The user may click on “All Music” 803 to return the set of all music (FM stations, CDs, DVD Audio and PC files) in the library. The user may click on “All Tracks” 804 to return the set of all individual tracks in the library. The user may click on “All Playlists” 805 to return the set of all playlists in the library. The user may click on “All Channels” 806 to return a set of all television channels in the library. The user may select a rating 808 then click on “Movies by Rating” 807 to return a set of all movies in the library that are of the requested rating. The user may select a genre (i.e. Science Fiction or Drama) in 810 then click on “Movies and Series by Genre” 809 to return a set of all movies and television series matching that genre in the library. The user may enter a partial name such as “Love” in the title text box 812 then click on “Items Named With” 811 to return a set of all media items (DVDs, CDs, tracks, channels, playlists) matching that name in the library. The user may enter an artist name 814 then click on “Items With Artist” 813 to perform a search of the media library by artist. If the user enters a value in one of the boxes 808, 810, 812, or 814, and then presses the Next button 815, the search corresponding to the requested data is performed.

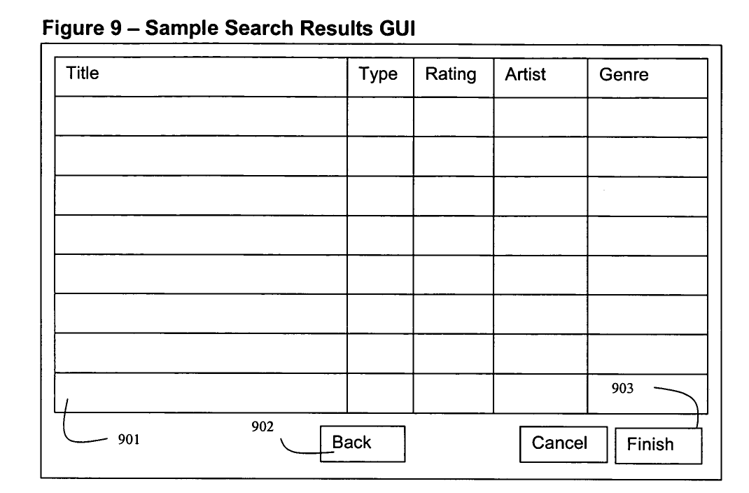

FIG. 9 shows a contemplated search results interface 900. This form shows the titles that match the users search criteria 901, along with the type of media found, rating (if available), the artist (if available) and the genre (if available). If the user did not find the item that he was looking for, he can press the Back button 902 to return to the previous view (FIG. 8) and search again. For any item in the list 901, the user can either double click the item to select it, or press the Finish button 903 to select the media.

### Media Selection

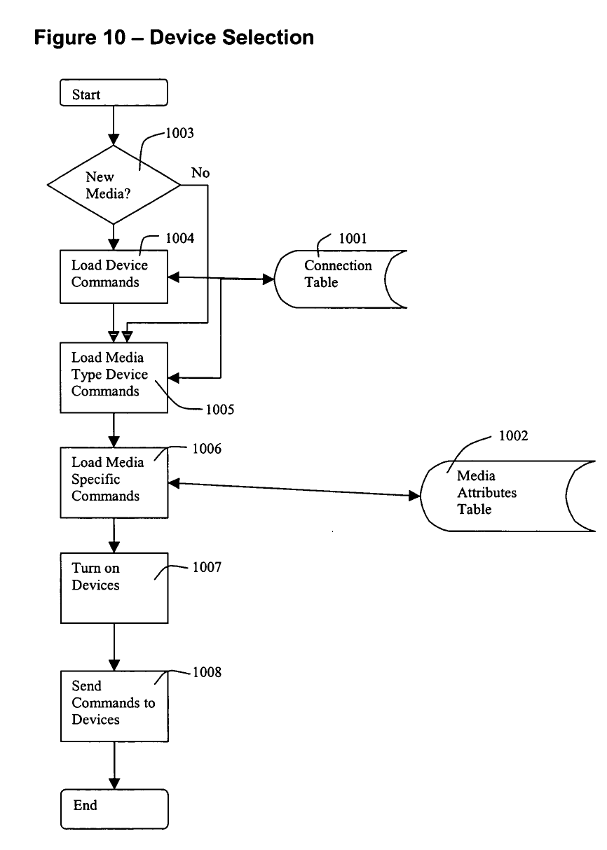

FIG. 10 shows a contemplated media selection process 1000, which starts by checking 1003 to see if a new media is requested, or if this is a continuation of a selection process. If this is the start of a selection process 1004 then the commands to send to devices is loaded from the Connections database table 1001. These are the commands to perform for any media on the device, regardless of the specific type of media, for example, a jukebox that contains both CDs and DVDs requires the receiver turned on. After the device selection commands have been loaded, the media type commands for the device are loaded 1005. The device media type commands are those that apply to the combination of the media type being selected and the device being selected, for example those that apply to DVDs instead of CDs in the jukebox. Next, any media specific commands are loaded 1006 is determined by joining the Media Attributes table 1002 with the Connection table 1001, joined by the type ID key. These commands are the ones that apply to the primary attributes of the specific media, for example, setting the TV mode for a 4×3 aspect ratio DVD. For each device in the device list, a power on command is sent to the device 1007. Then for each of the commands in the composite command list, the command is sent to the corresponding device 1008

FIG. 10 shows a contemplated device command loading process 1100 for 1004, 1005 and 1006 shown in FIG. 10. The database is queried 1101 on the IRCodes table 1102, joined by other conditions specified from the device selection process previously described. For each command loaded, the command is added to the composite list of commands 1103. If the device object associated with the command has not yet been instantiated, then a new instance of the device object is created 1104 and added to the device list.

### Database Schema

A database is used as the persistent store for its data, which allows large amounts of data to be easily stored, but also allows highly optimized database engines to query the database to provide the fastest access. As the data is stored in a database, some data may not be present, or null in database terms.

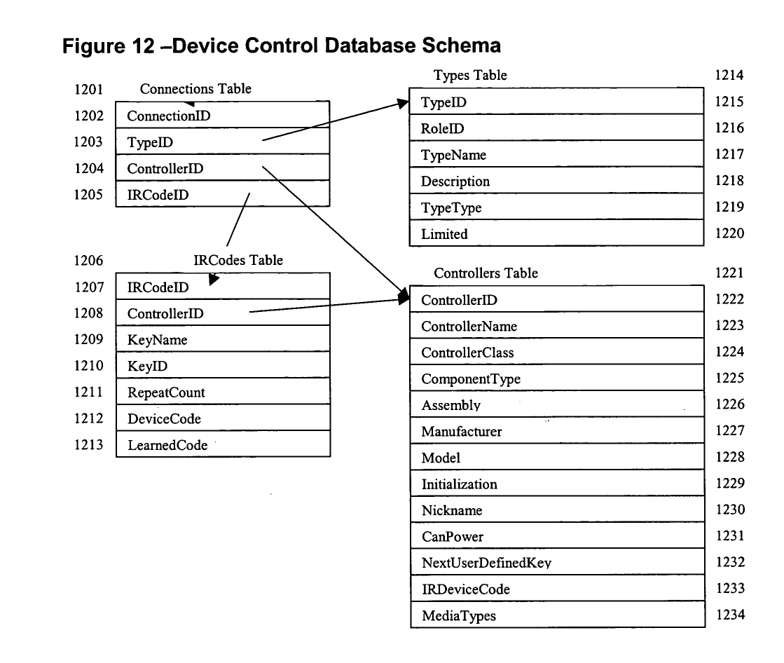

FIG. 12 shows a contemplated partial database schema 1200 related to the device control. The Connections Table 1201 is one of the most important tables because it holds the set of buttons to press for selected media. The ConnectionID field 1202 is a unique value for each entry in the table. The TypeID field 1203, when present, is a key into the Types table 1214 that represents a specific media type. The ControllerID field 1204, when present, is the key into the Controllers table 1221 that represents a controller specific button sequence. The IRCodeID field 1205 is the key into the IRCodes table 1206 that is a specific button for a specific controller. The IRCodes table 1206 is a table containing the command for a single button of a single device. The IRCodeID field 1207 is a unique value for each entry in the table. The ControllerID field 1208 is a key into the Controllers table 1221 that represents the device associated with the button. Note that the ControllerID field 1208 is the key for a different device than the other ControllerID field 1204. The KeyName field 1209 is a string that represents the user-friendly name for the button, the KeyID field 1210 represents the internal identifier for the button in the contemplated embodiment of the disclosed subject matter. The Repeat count field 1211, when present, is the number of times to repeat an infrared sequence, sometimes necessary with learned infrared codes. The DeviceCode field 1212 is a code that is the infrared controller's unique button identifier, the LearnedCode field 1213 is a variable length binary field that when present is a sequence of bytes for a learned infrared code, sent back to the controller when the learned button needs to be sent. The Controllers table 1221 is the set of devices defined by the user. The ControllerID field 1222 is a unique value for each entry in the table. The ControllerName field 1223 is a user-friendly name for the device. The ControllerClass field 1224 is the fully qualified type name of the class to create to handle the device interface. The ComponentType field 1225 provides a generic value for the device function. The Assembly field 1226 is the name of the assembly (or .DLL as is more commonly known) that contains the code that implements the device interface. The Manufacturer field 1227 is the name of the manufacturer of the device. The Model field 1228 is the name of the device model. The Initialization field 1229 is a variable length binary field containing the serialized form of the initialization parameters for the device. The Nickname field 1230 is a user assigned friendly name for the device, used for the button labels shown at the top of FIG. 6. The CanPower field 1230 is a Boolean field to indicate if the device understands power on and off commands. The NextUserDefinedKey field 1232 is the value of the next available value for KeyID 1210 for user-defined keys. The IRDeviceCode field 1233 is the unique identifier for the infrared controller of the device code used for device codes preprogrammed into the infrared controller. The MediaTypes field 1234 is a comma-separated list of the media types supported by the device.

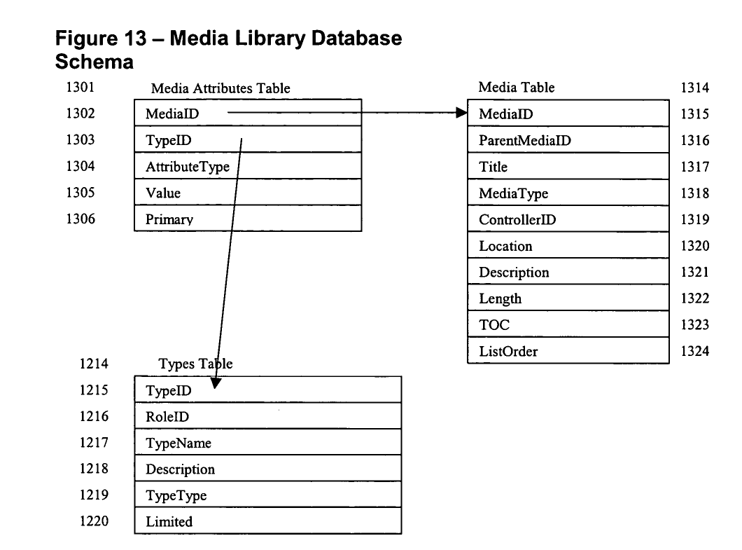

FIG. 12 also shows the Types table 1214. This table is shown in both FIG. 12 and FIG. 13. The types table holds predefined types used in the media library, such as the enumerated set of ratings, the enumerated set of aspect ratios, the enumerated set of genre, etc. The TypeID field 1215 is a unique value for each entry in the table. The RoleID field 1216, when present, is an enumerated integer value that is unique for a given TypeType 1219. The TypeName field 1217 is a user-friendly description for the type. The Description field 1218, when present, is a longer user-friendly description of the type. The TypeType field 1219 is an enumerated value for a set of predefined types for the media library. The Limited field 1220, when present, is a Boolean flag that when set indicates the type is available to limited security user accounts.

FIG. 13 shows a contemplated partial database schema 1300 related to the media library. The Media table 1314 is the primary table that contains the description of each item in the user's media library. The MediaID field 1315 is a unique value for each entry in the table. The ParentMediaID field 1316, when present, is a key into some other entry in the Media table that represents the containing media. The Title field 1317 is the title of the media. The MediaType field 1318 is an enumerated type that describes the media, such as DVD, CD, FM station, CD track, PC MPEG file, etc. The ControllerID field 1319 is the key into the Controllers table that represents the device that contains the media. The Location field 1320, when present, represents the location of the media whether a slot in a jukebox, a file name, the channel number, or whatever is relevant to the device that contains the media. The Description field 1321, when present, is a description of the media, most commonly the synopsis for the media. The Length field 1322, when present, is the length of the media if known. The TOC field 1323 is a string that uniquely identifies a media on the device, regardless of location. The ListOrder field 1324 is a sequence for contained media items. The MediaAttributes table 1301 contains additional attributes about a specific media. Attributes such as genre, rating, audio modes and aspect ratios are stored in this table. The MediaID 1302 is a unique key into the Media table 1214. The TypeID 1303 field is a unique key into the Types table 1214. The AttributeType field 1304 is an enumerated value for the available media attributes the same set of enumerated values as the TypeType field 1219. The Value field 1305, if present, is the value of the attribute. When not present, the value is retrieved from the Types table 1214. The Primary field 1306 is a boolean flag indicating which attribute from a set of the same attribute types 1304 for a media is the primary attribute, the one used to set device modes when the media is selected. Only one attribute of a set of attribute types for a media may be the primary attribute. For example, a media may have two aspect ratios to choose from, 1.85:1 and 4×3. Only one of those aspects can actually be selected for the media, and thus is the primary attribute.

In some embodiments, security systems can be put in place and applied to the computer readable information contained in the media library. This software security allows a person with a high security access to define the attributes used to filter the view of the media library to those persons with lower security access. The attributes that can be used include the rating of a movie or show, or the genre of the show, such as violence or language. Computer security is combined with playlists to give each user their own set of favorites.

Electronic program guides are also contemplated to show to the user the set of television shows currently broadcasting, as well as the set of television shows broadcasting in the future. The date through which the electronic program guide is valid may vary depending on the source of the electronic program guide. The electronic program guide is used to select the channel that the user wishes to watch, and is also used to schedule future recordings of television programs. The electronic program guide is also a library, and can be searched like the media content owned by the user.

### Hardware Configuration

As discussed earlier, a media management system is described herein that includes: a) a computer, b) a media library, c) at least one device that can utilize at least part of the media library, d) a software code that executes a management system on the computer, wherein the management system accesses or manipulates at least one of the media library or the at least one device, and e) a graphical user interface that is coupled to the computer.

FIG. 14 shows a contemplated hardware arrangement 1400 for utilizing the electronic/software multimedia library control system. Monitor 1410 is coupled to the Central Processing Unit or CPU 1420. Hub 1430 is also connected to the CPU 1420 either by conventional wiring or by wireless transmitters. Hub 1430 is either connected to and/or communicates wirelessly with the Devices 1440 defined herein, such as a VCR, CD Player, Satellite Radio interface, TV, second computer, etc. Each of these Devices 1440 comprises a Set of Media 1450 that, along with the information about that media, makes up the Media Library 1460, and wherein each Set of Media 1450 may be contained either as a separate entity 1465 from the Device 1440, such as in the case of a TV which accesses a signal that transmits content from an outside location, or as an integrated entity 1475 in the Device 1440, such as in the case of a CD Player which internally houses at least one CD Rom. The multimedia library control system (not shown) is stored on the CPU 1420. The graphical user interface 1480 comprises the Monitor 1410 and a projected image 1415 that graphically displays the contents and other related data of the media library, as collected by the multimedia library control system discussed earlier.

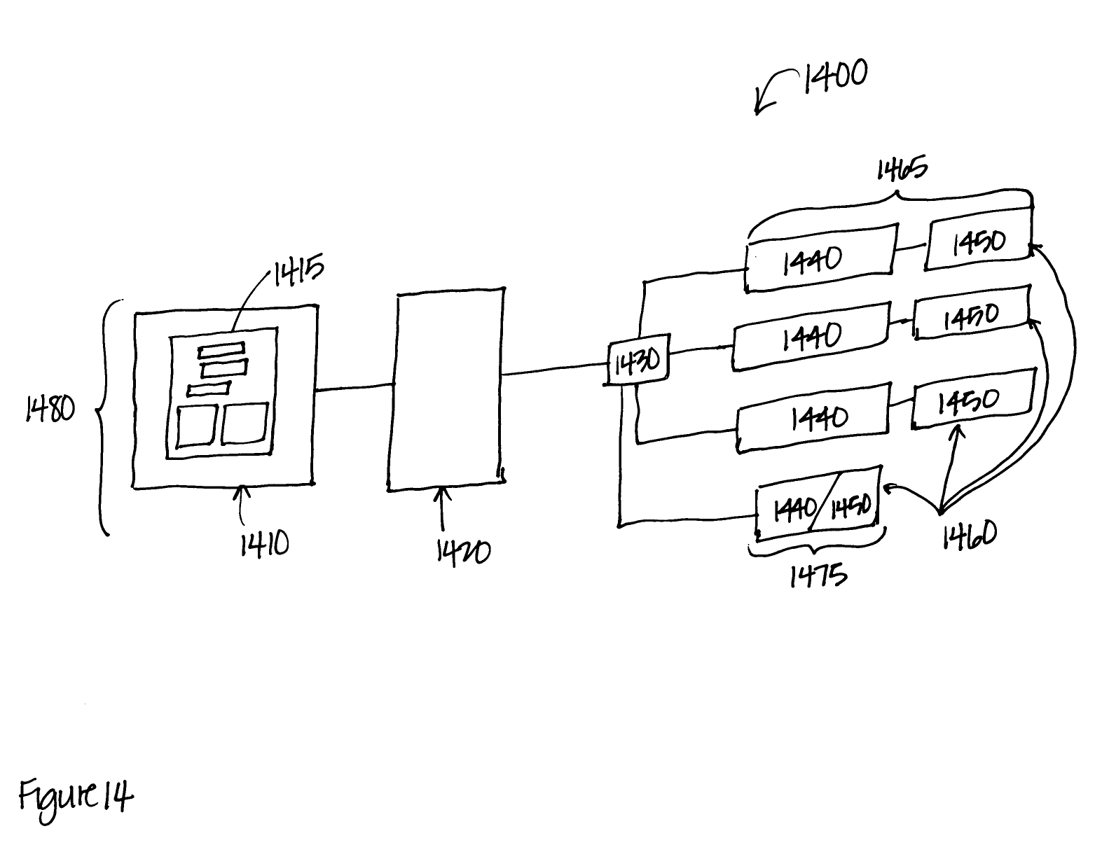

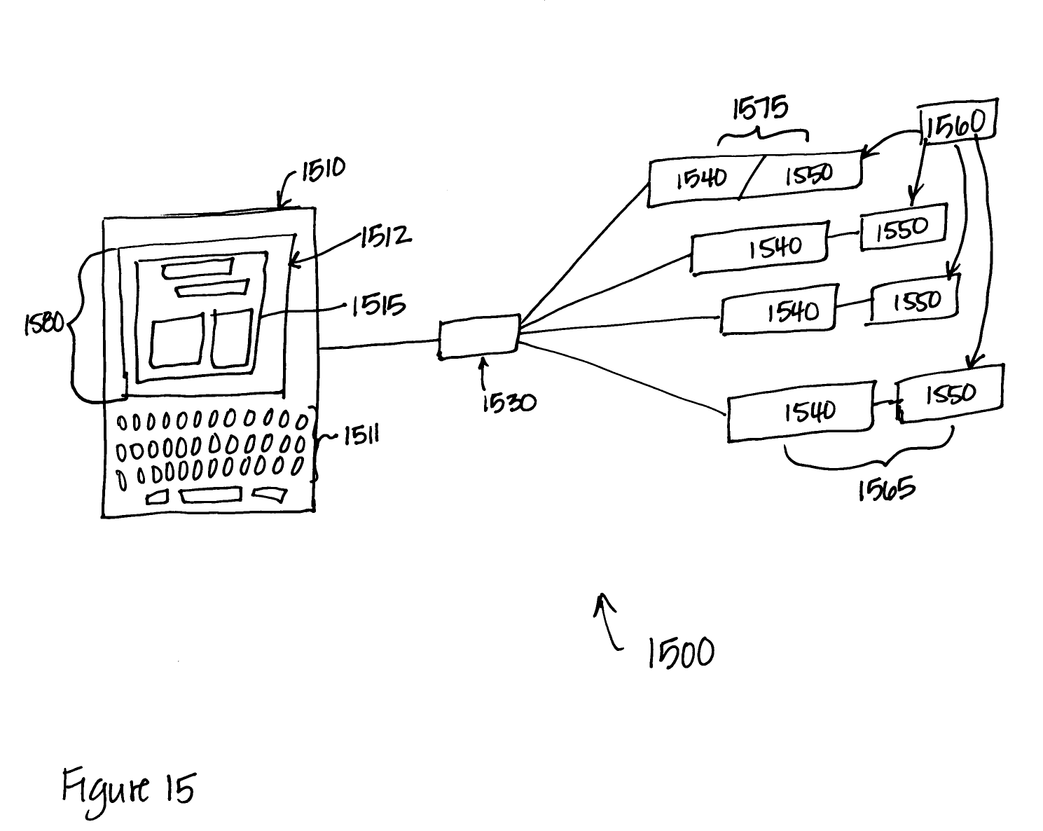

FIG. 15 shows another contemplated hardware arrangement 1500 for utilizing the electronic/software multimedia library control system. The Monitor and CPU are contained within the same Integrated Housing 1510, such as what might be found in a laptop computer or a handheld device. FIG. 15 shows a handheld device 1510, which contains an integrated keyboard 1511. Hub 1530 is connected to the Housing 1510 either by conventional wiring or by wireless transmitters. Hub 1530 is either connected to and/or communicates wirelessly with the Devices 1540 defined herein, such as a VCR, CD Player, Satellite Radio interface, TV, second computer, etc. Each of these Devices 1540 comprises a Set of Media 1550 that, along with information about that media, makes up the Media Library 1560, and wherein each Set of Media 1550 may be contained either as a separate entity 1565 from the Device 1540, such as in the case of a TV which accesses a signal that transmits content from an outside location, or as an integrated entity 1575 in the Device 1540, such as in the case of a CD Player which internally houses at least one CD Rom. The multimedia library control system (not shown) is stored on the Integrated Housing 1510. The graphical user interface 1580 comprises the Display 1512 and a projected image 1515 that graphically displays the contents and other related data of the media library, as collected by the multimedia library control system discussed earlier.

Several embodiments disclosed herein treat the consumer electronics devices as peripherals controlled by the computer. The interface to these devices may be one-way, as in the case of a device that must be controlled using infrared signals, or two-way, as in the case of a device that contains a computer compatible connection such as an RS-232C port.

### System Configuration

Although not critical to the behavior of the contemplated system, the software configuration of the system plays an important role. The software configuration of the contemplated system is where a user defines the devices and behaviors of their unique entertainment systems.

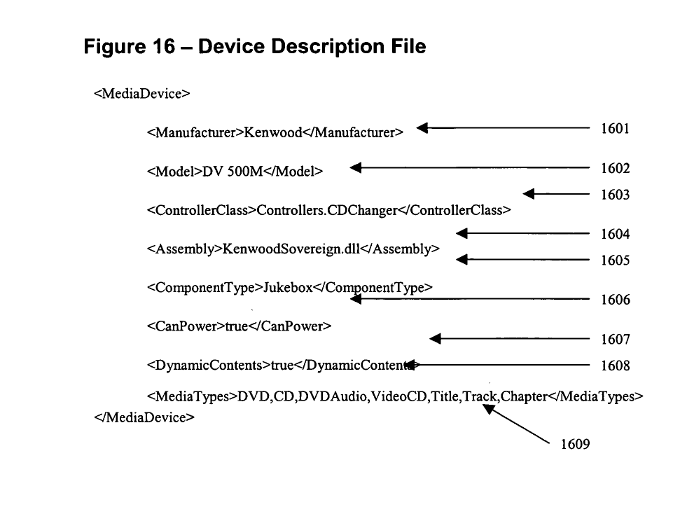

Configuration of the contemplated system begins by defining the devices used in the system. The device driver for a particular entertainment device typically consists of one or more software modules along with a description of the driver. An external file provided by the supplier of the contemplated software describes the driver. A description file depicted in FIG. 16 defines the characteristics of the device to add, including the manufacturer 1601, model name 1602, device driver module 1604, the software object class to instantiate 1603. The type of component 1605 may be one of several types (i.e. receiver, jukebox, satellite receiver, TV channel, DVR, etc) the media types supported 1609 (i.e. DVD, DVD Audio, CD, AM, FM, etc), whether the device supports the Power command 1606, whether the device contents can be dynamic 1607 (as in the case of a jukebox). Finally, the device can define an infrared code 1608 used with the infrared controller.

The configuration of the device consists of several aspects. The device configuration includes the names by which the device is known as, the keys that the device exposes to the rest of the user interface, and possibly some device specific properties. The device configuration allows the driver to supply one of more configuration pages for the user.

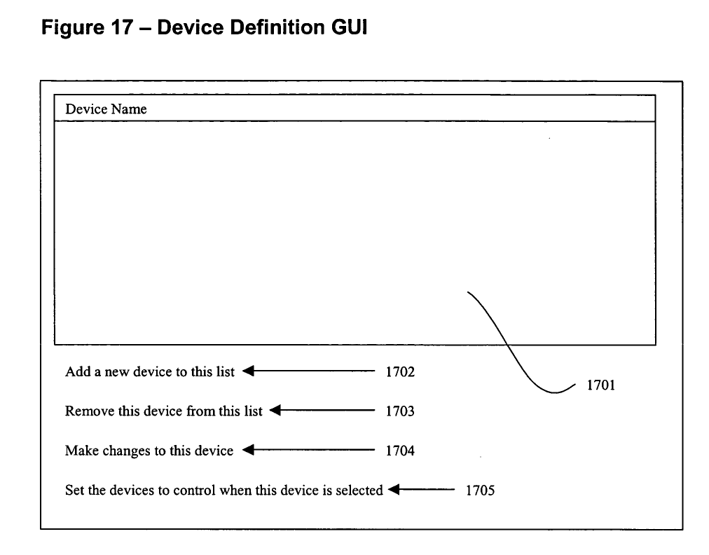

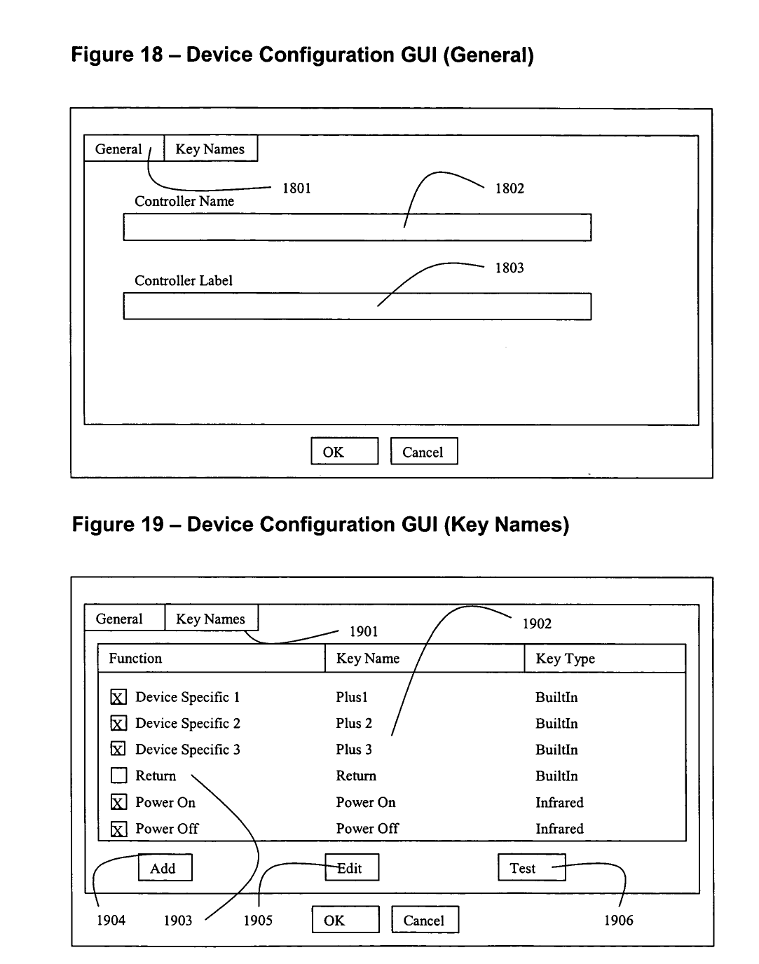

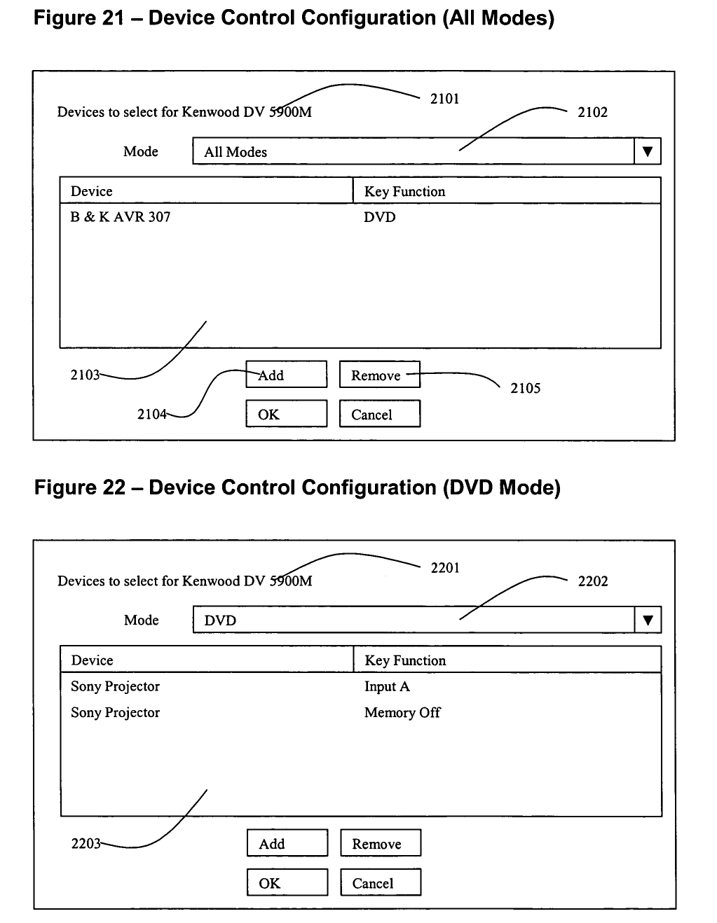

FIG. 17 shows a contemplated device list form 1700. The devices currently installed in the contemplated system are shown in the list 1701. To add a device, the user clicks “Add a device to this list” 1702 to search for new device drivers. To remove a device the user clicks on a device in the list 1701 and then clicks on “Remove this device from this list” 1703. Similarly, to make changes to the device the user clicks on a device in the list 1701 and then clicks on “Make changes to this device” 1704, which brings the user to contemplated device configuration user interface FIG. 18. Finally, to specify related devices the user clicks on a device in the list 1701 then selects “Specify the devices to control when this device is selected” 1705, which brings the user to contemplated device control configuration FIG. 21.

FIG. 18 shows the contemplated device configuration user interface with the General page 1801 displayed. This allows the user to change the name 1802 the system refers to the device as, and assign a friendly name 1803 used on the labels as shown in 701, 702, 703, 704, 705 and 706 in FIG. 7.

FIG. 19 shows the same GUI 1900 as in FIG. 18, but with the Key Names tab 1901 selected. This contemplated interface also allows the user to define or restrict the set of key functions available in the user interface. The list of keys defined for the device is display in 1902, with a check box to the left of each key to allow the user to disable a particular key. In the sample shown, the Return key 1903 is unchecked, and this is unavailable to the rest of the user interface. The user can define a new remote key or key sequence using the infrared controller by pressing the Add button 1904. The user can also change the text of a key name by pressing Edit 1905. Finally, the user can test that the key performs its correct function by pressing the Test button 1906.

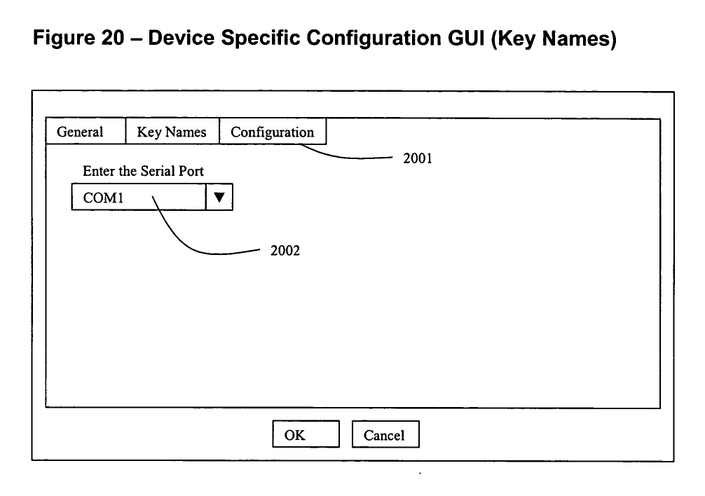

FIG. 20 shows the same GUI 2000 as in FIG. 18, but with the Configuration tab 2001 selected. This configuration page is supplied by the device driver to allow the user to configure specific properties for this particular device. The RS 232 port 2002 connected to a device is one such property that may show up on these device supplied configuration pages.

The configuration for a particular device includes a user interface to specify the set of devices to control when that particular device is selected. For example, once the receiver, TV and DVD player devices are added to the system, the user can specify that when a media in the DVD play is selected, the receiver is switched to the DVD input and the TV is switched to the component video input This aspect of the configuration is where the features unique to the contemplated embodiment are found.

The device control configuration allows the user to specify the devices that are controlled when a media in a particular device is selected. For example, for the DVD player, it can be set up to switch the input of the receiver to the DVD input for all modes (CD, DVD Audio and DVD if the player supports all these modes). The user can also specify that for the DVD mode, the TV is switched to the component video input, or for CD mode, the receiver is switched into Stereo mode. The user can add or remove key sequences associated with that particular mode.

FIG. 21 shows the contemplated device control configuration user interface 2100. This shows that the configuration is for the device called “Kenwood DV 5900M” as shown in the label 2101. The list of available modes is shown in the combo box 2102. The list 2103 shows the devices controlled for a particular mode. In the sample shown, for any of the media selected in the Kenwood DV 5900M device (a DVD/CD jukebox), the receiver B & K AVR 307 is sent the DVD key function. The user can click on the Add button 2104 to add a key sequence to the device mode, or if an item in the list 2102 is selected, the user can click on the Remove button 2105 to remove the key function.

FIG. 22 shows the same contemplated GUI as FIG. 21, but with the DVD mode selected. This also shows the configuration for the device called “Kenwood DV 5900M” but this with the DVD mode selected 2202. The list 2203 shows that for the DVD mode, the device called “Sony Projector” is sent the key function “Input A” as well as the key function “Memory Off”.

Another user interface allows the user to configure device modes. This configuration allows a user to define the devices controlled when a particular device mode is selected. For example, when a DTS media is selected, the receiver can be switched to the DTS sound mode.

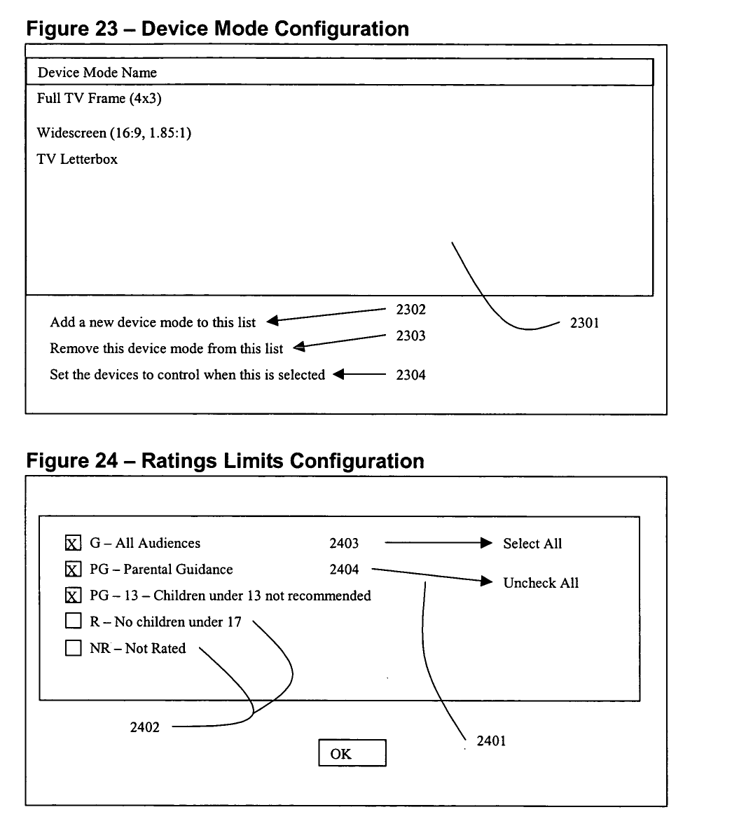

FIG. 23 shows the contemplated device mode configuration user interface 2300. This shows the list currently configured device modes 2301. This sample shows the modes “Full TV Frame (4×3)”, “Widescreen (16:9, 1.85:1)” and “TV Letterbox” have been configured. The user can click on “Add a new device mode to this list” 2302 to add a device mode. If an item in the device mode list 2301 is selected, the user can also click on “Remove this device mode from this list” 2303 or “Set the devices to control when this is selected” 2304 to change the devices selected. The add selection 2302 and the “Set the devices” selection shows the user the device control configuration user interface FIG. 21 but with the label 2101 and combo box 2102 invisible.

Finally, the configuration user interface allows the user to define ratings limits. These limits define the media that non-privileged users are permitted to access. FIG. 24 shows the contemplated user interface for configuring ratings limits. This figure shows that there are 5 ratings in the list 2401, and that for any media that is rated R or NR as shown 2402 would not be available to a non-administrative user. The user can click on “Select All” 2403 to check all boxes in the list, or “Uncheck All” 2404 to uncheck every box in the list.

### EXAMPLES

One contemplated embodiment of the electronic/software multimedia control system is shown on the accompanying CD Rom entitled “Electronic Multimedia Library Patent”, which is lodged in duplicate (COPY 1 and COPY 2) with the United States Patent & Trademark Office at the time of filing of this application and which is incorporated herein in its entirety by reference. This Compact Disc is compatible with IBM-type hardware and Microsoft Windows Applications. A catalog of the files contained on the “Electronic Multimedia Library Patent” CD Rom, along with the size of each file and the date created on the “Electronic Multimedia Library Patent” CD Rom is found in Table 1.

TABLE 1
Application

bin [empty file]
Controls

Form Controls

bin

Debug

Form Controls.pdb (32 KB created 8/5/04)
FormControls.dll (63.5 KB 8/5/04)

obj

Debug

temp [empty file]
TempPE [empty file]
ByteBuilderFormControls.ComboBox.resources (188 KB

8/5/04)

ByteBuilder.FormControls.GradientForm.resources (188 KB

| | |
|---|---|
| 8/5/04) | ByteBuilder.FormControls.SerialPanel.resources |
| (188 KB 8/5/04) | |

FormControls.dll (32 KB created 8/5/04)
FormControls.pdb (63.5 KB 8/5/04)
FormControls.projdata (16.6 KB 8/7/04)

AssemblyInfo.cs (2.41 KB 12/29/03)
ComboBox.cs (3.62 KB 12/30/03)
ComboBox.resx (1.69 KB 1/29/02)
ControlSerializer.cs (5.52 KB 1/7/04)
FormControls.csproj (5.47 KB 1/7/04)
FormControls.csproj.user (1.76 KB 8/7/04)
GradientForm.cs (4.18 KB 12/30/03)
GradientForm.resx (1.69 KB 1/29/02)

The files that are contained on the “Electronic Multimedia Library Patent” CD Rom are those that constitute one embodiment of a contemplated media library system, as described in the patent application. These files require Visual Studio NET 2003 to build. To build the software, open the FullBuild project in the Setup directory, the file Setup\FullBuild.sln. Most of the files are text files. A few not, such as those with a file extension of .GIF, .JPG, .PSD, .SNK, .ICO and .SUO.

The following is a list of the text file extensions and their use:
.CS are C Sharp source files, compiled with Visual Studio .NET 2003.
.RESX are XML resource files, typically forms layout information
.CSPROJ are the Visual Studio project files, which defines the files used to build an assembly (a module).
.SQL are SQL scripts used for creating the database.
.MODEL are XML configuration files used by the application software to install devices.
   All of the software source code has been printed to Adobe Acrobat PDF files. The directory called PDFs-1 Page is formatted with one logical page to one physical page. The directory called PDFs-2 Page is formatted with two logical pages to one physical page. The directories are numbered and named in the print order, and the files are numbered and named for sequential printing as well. A copy of the directory and its contents called PDF-2 Page is included herein in Appendix A.

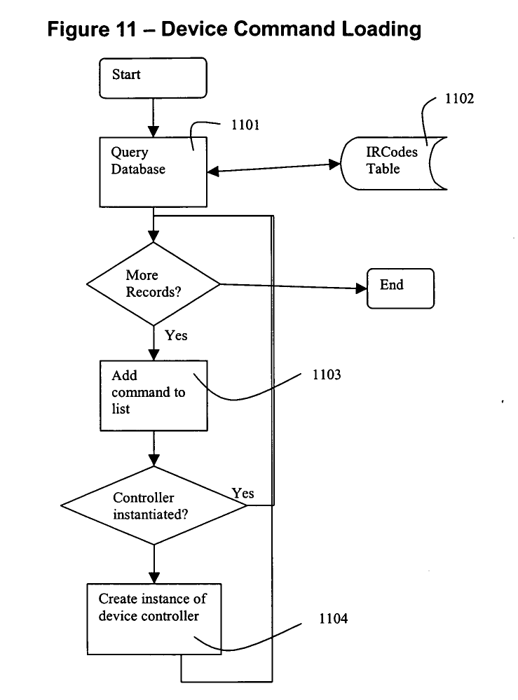

The graphical interfaces described in the patent application are in the Application directory on the “Electronic Multimedia Library Patent” CD Rom. FIG. 1 is contained in the file Player.cs. FIGS. 2, 3, 4, 5 and 6 are contained in the file MediaEdit.cs. FIG. 7 is contained in the file TrackList.cs. FIGS. 8 and 9 are contained in the file Search.cs. The flowcharts represented in FIGS. 10 and 11 are contained in RemoteManager.cs. The database schema represented in FIGS. 12 and 13 are contained in the file HomeTheater.sql in the directory MediaManagerService.

The remaining directories on the “Electronic Multimedia Library Patent” CD Rom represent code necessary to support the features describes in the patent application. The ComPort directory represents the part of the code used to communicate with RS-232 based devices. The directory MediaLib represents the device control interface along with associated structures, the remote procedure call interface when the client communicates with the server, along with the core database access code. Controllers represents the core of the device control features, including the remote procedure call server, the device interface to the Windows media player, the infrared controller and a receiver manufactured by B&K Components. Directories underneath the Controllers directory includes:
KenwoodSovereign device driver, which controls a Kenwood DV-5900M DVD jukebox
ConsoleVideo device driver that plays a video on the PC through the PC's console (which may not be the same as the interface used to control the PC)
TivoWeb directory contains the device driver TiVo personal video recorder
SonyProjector device driver for controlling a Sony VPL-VW11HT projector
WinTV device driver for controlling a Hauppage WinTV PVR-250 capture card. This device is a personal video recorder for PCs.

The Guide directory comprises the software the provides the base functionality for the electronic program guide as described in the patent, with subdirectories for a few guide data providers:
TitanTV is the older interface to www.titantv.com for their offline electronic program guide. The offline electronic guide is no longer supported by TitanTV, so this directory merely serves as yet another example of an interface to an electronic program guide provider.
XmlTV is the interface to the open source project called XmlTV, which gets electronic program guide data from various providers across the globe.

Zap2itDD is the interface to the electronic program guide data provided by www.zap2it.com, a web site operated by Tribune Media Services.

The core of the user interface is contained in the Application directory, along with the some custom controls used within the application in the FormControls directory, and the electronic program guide control used to display and control the program guide. The MMExIm directory contains some software for exporting from and importing to the media library. This utility is used when backing up or restoring the database.

Thus, specific embodiments, methods of use and applications of an electronic/software media library system have been disclosed. It should be apparent, however, to those skilled in the art that many more modifications besides those already described are possible without departing from the inventive concepts herein. The graphical interface presented to the user may vary from those graphical interfaces depicted in this subject matter without departing from the inventive concepts. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A method of controlling a media library, comprising:
providing a media library comprising information related to a plurality of media,
providing at least one device that can utilize or access at least part of the information related to the plurality of media in the media library,
providing an executable media library management system; and
utilizing the management system to manage at least part of the information related to the plurality of media in the media library, to operate the at least one device or a combination thereof.

2. The method of claim 1, wherein the media library comprises a plurality of media.

3. The method of claim 2, wherein the plurality of media comprises at least one compact disc, at least one digital video disc, at least one AM radio station, at least on FM radio station, at least one satellite radio station, at least one television station, at least one VCR tape or a combination thereof.

4. The method of claim 1, wherein the at least one device comprises a CD player, a DVD player, a radio signal transmitter, a satellite signal transmitter, a VCR player, a television or a combination thereof.

5. The method of claim 2, wherein the at least one device accesses the computer-readable information about the media library.

6. The method of claim 1, wherein the management system comprises a software code.

7. The method of claim 1, wherein utilizing the management system comprises executing a software code.

8. A software code that executes the management system of claim 1.

9. A media management system, comprising:
a computer,
a media library comprising information related to a plurality of media,
at least one device that can utilize or access at least part of the media library,
a software code that executes a media library management system on the computer, wherein the media library management system accesses or manipulates the information related to at least part of the plurality of media in the media library or the at least one device, and
a graphical user interface that is coupled to the computer.

10. The media management system of claim 9, wherein the computer comprises a desktop computer, a laptop computer, a handheld computer, an embedded computer built specifically for this system, or a combination thereof.

11. The media management system of claim 9, wherein the graphical user interface comprises a computer screen, a monitor, a handheld device, an LCD screen or display, a TV screen, a laptop computer screen or a combination thereof.

12. The media management system of claim 7, wherein the media library comprises a plurality of media.

13. The media management system of claim 12, wherein the plurality of media comprises at least one compact disc, at least one digital video disc, at least one AM radio station, at least on FM radio station, at least one satellite radio station, at least one television station, at least one VCR tape or a combination thereof.

14. The media management system of claim 7, wherein the at least one device comprises a CD player, a DVD player, a radio signal transmitter, a satellite signal transmitter, a VCR player, a television or a combination thereof.

15. The media management system of claim 7, wherein the at least one device accesses the computer-readable information about the media library.

16. The media management system of claim 9, wherein the software code comprises a search function that can search the media library by media type, genre, rating, title, artist or a combination thereof.

17. The media management system of claim 9, further comprising an electronic program guide.

18. The media management system of claim 9, further comprising at least one security method or device.

19. A graphical user interface, comprising:
a display device; and
a projected image that graphically displays a set of media information collected by a multimedia library control system software.

20. The graphical user interface of claim 19, wherein the display device comprises a computer screen, a monitor, a handheld device, an LCD screen or display, a TV screen, a laptop computer screen or a combination thereof.
